(19) United States
(12) Patent Application Publication
(10) Pub. No.: US 2006/0083852 A1
(43) Pub. Date: Apr. 20, 2006

(54) Fuel cell apparatus and method of manufacture thereof

(76) Inventor: Yoocham Jeon, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/968,724

(22) Filed: Oct. 18, 2004

(51) Int. Cl. B05D 5/12; H01M 8/10; H01M 8/02; H01M 4/92

(52) U.S. Cl. 427/115; 429/34; 429/30; 429/33; 429/40

(57) ABSTRACT

Metal-coated polymer electrolyte membranes permeable to protons/hydrogen and methods of manufacturing thereof are disclosed. A fuel cell may be produced using a substrate, with the resultant design having a thin metal layer, such as palladium, positioned between two layers of a porous metal, such as palladium black, and optionally at least one layer of a polymer electrolyte. An alternate design uses at least one layer of a porous metal, such as palladium black, and optionally one or more layers of platinum black, in combination with a mold, sacrificial layer, and optional microstructure.

### BACKGROUND OF THE INVENTION

1. Field of the Invention

The present invention relates generally to the art of electrolyte membranes, and more specifically to the use of electrolyte membranes in electrochemical devices, such as fuel cells.

2. Description of the Related Art

Certain types of fuel cells employ a liquid fuel, such as methanol, and an oxygen-containing oxidant, such as air or pure oxygen. Such fuel cells oxidize the methanol at an anode catalyst layer to produce protons and carbon dioxide. The protons migrate through a proton exchange membrane or polymer electrolyte membrane (PEM) from the anode to the cathode. At a cathode catalyst layer, oxygen reacts with the protons to form water. The anode and cathode reactions in this type of direct methanol fuel cell are shown in the following equations:
Anode reaction (fuel side): CH₃OH+H₂O→6H⁺+CO₂+6e⁻ I
Cathode reaction (air side): 3/2O₂+6H⁺+6e⁻→3H₂O II
Net: CH₃OH+ 3/2O₂→2H₂O+CO₂ III

The two electrodes are connected within the fuel cell by an electrolyte to transmit protons from the anode to the cathode. The electrolyte can be an acidic or alkaline solution, or a solid polymer ion-exchange membrane characterized by a high ionic conductivity.

PEMs such as Nafion™ are widely used in low temperature fuel cells due to the electrolyte membrane's high proton conductivity and excellent chemical and mechanical stability. Since the electrolyte membrane is a polymer having a hydrophobic backbone and highly acidic side branches, the membrane typically contains significant amounts of water to conduct protons from the electrode reactions. Therefore, a polymer electrolyte membrane may be kept in high humidity environment to maintain high proton conductivity.

PEM fuel cells use basically the same catalyst for both anode and cathode. In addition to undergoing electro-oxidation at the anode, a water soluble liquid fuel, such as methanol, may permeate through the PEM and combine with oxygen on the surface of the cathode electrocatalyst. This process is described by equation III for the example of methanol. This phenomenon is termed “fuel crossover”. Fuel crossover is an adverse effect that lowers the operating potential of the oxygen electrode and results in consumption of fuel without producing useful electrical energy. In general, fuel crossover is a parasitic reaction which lowers efficiency, reduces performance and generates heat in the fuel cell. It is therefore desirable to minimize the rate of fuel crossover.

There are a number of approaches to reduce fuel crossover. The rate of crossover is proportional to the permeability of the fuel passing through the solid electrolyte membrane and increases with increasing fuel concentration and temperature. One way of inhibiting methanol fuel crossover is placing a metal layer, such as palladium, over the polymer electrolyte. Such a layer is permeable to hydrogen only. Palladium is, however, a precious metal, and costs associated with palladium use can be significant. Further, making palladium as thin as possible to reduce hydrogen diffusion resistance entails rolling the palladium into a self standing thin film, which is a costly process. Thinner films may be fabricated using vapor deposition or electromechanical deposition, but the resultant product is typically too delicate to handle throughout the fuel cell fabrication process. Depositing the film directly on the polymer electrolyte membrane enables safe film handling through the fuel cell fabrication process. However, the flat interface between the metal film and the polymer electrolyte membrane provides a relatively small hydrogen transport rate, which is undesirable.

Improvements in fuel cell reaction rate of the fuel cell can typically occur in two ways, increasing surface area or employing a catalyst. While certain porous catalyst layers can be helpful when used in combination with liquid electrolytes, application of a porous catalyst layer to a solid electrolyte, such as Nafion™, may be very difficult. Further, although use of a porous catalyst layer may enhance surface area, the amount of surface contact may be significantly decreased, which again is undesirable.

Further issues with fuel cells employing precious metal layers such as palladium include proton transport efficiency. Proton transport from the hydrogen permeable metal layer to the electrolyte is an electrochemical reaction, and efficient proton transport requires an adequate electrical bias across the interface to enhance the reaction rate. A voltage drop in the cell is the only way to achieve a sufficiently high current, as current may be carried within the cell, including across the interface, by protons alone. While use of a palladium layer may block fuel crossover, if use of palladium layer requires electrical bias across the interface and causes a significant decrease in proton transport, the palladium layer may inhibit rather than enhance overall cell performance.

Therefore, there remains a need for fuel-impermeable electrolyte membranes that are easily manufacturable and at the same time overcome problems associated with previously known designs, such as fuel crossover and limitations in proton transport efficiency.

### SUMMARY

According to a first aspect of the present design, there is provided a method for producing a fuel cell. The method comprises providing a substrate, depositing a metal layer on the substrate, depositing a porous metal layer on the metal layer, releasing the metal layer and porous metal layer from the substrate, and depositing a second porous metal layer on the metal layer.

According to an alternate aspect, there is provided a fuel cell apparatus formed using a substrate. The fuel cell apparatus comprises a layer of metal applied to the substrate, a porous metal layer applied to the metal layer, a polymer electrolyte coating on the porous metal layer, forming a polymer electrolyte coated porous metal layer, and a polymer electrolyte membrane on the polymer electrolyte coated porous metal layer.

These and other objects and advantages of all aspects of the present invention will become apparent to those skilled in the art after having read the following detailed disclosure of the preferred embodiments illustrated in the following drawings.

### DESCRIPTION OF THE DRAWINGS

The present invention is illustrated by way of example, and not by way of limitation, in the figures of the accompanying drawings in which:

FIG. 1 illustrates application of layers to a substrate according to an enhanced fuel cell design;

FIG. 2A illustrates a polymer electrolyte membrane absorbing water in a high humidity environment and expanding in volume;

FIG. 2B represents a microtextured surface having multiple protrusions;

FIG. 3 shows removing the layers from the substrate;

FIG. 4 illustrates application of a frame to the layers;

FIG. 5 is the removal of the layers and frame from the substrate;

FIG. 6 shows application of an electrode and gas diffusion or current collecting layer;

FIG. 7A illustrates application of various layers to the palladium layer after removal from the substrate and optional cleaning, where the structure of FIG. 6 is illustrated but other structures may be employed;

FIG. 7B shows application of a second electrode and a second gas diffusion/current collecting layer.

FIG. 8A is a drawing of a mold or substrate used to form an embodiment of the fuel cell disclosed herein;

FIG. 8B illustrates deposition of a sacrificial layer on top of the mold or substrate;

FIG. 8C represents deposition of a continuous or relatively uniform layer of palladium on the sacrificial layer over the mold;

FIG. 8D shows deposition of a palladium-black layer on the continuous palladium layer;

FIG. 8E illustrates deposition of an optional platinum-black layer;

FIG. 8F represents providing a layer of dissolved electrolyte in solvent, such as liquid Nafion™;

FIG. 8G shows lamination of the Nafion™ on the cathode;

FIG. 8H illustrates removal of the mold or substrate;

FIG. 8I represents deposition of an optional second layer of palladium-black;

FIG. 8J shows deposition of an optional second layer of platinum-black;

FIG. 9 is a flowchart of an embodiment of the basic deposition arrangement of the present design;

FIG. 10 shows an alternate embodiment of the present fuel cell design;

FIG. 11 is another embodiment of the present fuel cell design, wherein two layers of palladium-black are deposited around the PEM;

FIG. 12 shows a proton/hydrogen permeable metal layer having a continuous metal layer between two porous metal layers;

FIG. 13 illustrates still another embodiment of the present design, wherein the electrode and catalyst are assembled simultaneously with the PEM;

FIG. 14 shows yet another embodiment of the present design, wherein a microstructure on the mold or membrane surface;

FIG. 15A shows a top view of an engraved microstructure mold or substrate;

FIG. 15B is a perspective view of an engraved microstructure mold or substrate where protrusions have different sizes;

FIG. 16A shows a top view of a configuration where protrusions are in a pyramidal shape with some limited flat surfaces between protrusions;

FIG. 16B illustrates a perspective view of the surface of FIG. 16A;

FIG. 17A shows a surface of a mold or substrate wherein each protrusion has a polyhedral shape;

FIG. 17B is a perspective view of the surface of FIG. 17A;

FIG. 18A is a surface of a mold having protrusions in a roof-like shape;

FIG. 18B is a perspective view of the surface of FIG. 18A;

FIG. 19 shows one aspect of fabrication of the microtextured mold or substrate surface;

FIG. 20 shows an alternate aspect for fabrication of the microtextured mold or substrate surface;

FIG. 21 graphically represents the process of fabricating the microtextured mold or substrate;

FIG. 22 is the final product formed by fabrication of the microtextured mold or substrate; and

FIGS. 23A, 23B, and 23C illustrate three embodiments of the present design.

### DETAILED DESCRIPTION

A polymer electrolyte membrane in a PEM fuel cell may benefit from having the following properties: high ion conductivity, high electrical resistance, and low permeability to fuel, gas or other impurities. However, none of the commercially available PEMs possesses all those properties. For example, the most popular PEM, Nafion™, exhibits high fuel crossover when used with liquid fuels.

One approach to block fuel crossover is to coat the polymer electrolyte membrane with a thin layer of metal, such as palladium (Pd), which is known to be permeable to proton/hydrogen but impermeable to hydrocarbon fuel molecules.

Fuel Cell Fabrication

The fuel cell may be fabricated in different ways. One way of fabricating the fuel cell employs a thin metal layer, such as a palladium thin film, and a porous metal, such as palladium-black, with deposition of layers to provide adequate contact with the polymer electrolyte membrane. The fabrication comprises providing a substrate, wherein one embodiment of the substrate includes a low adhesion surface, depositing a metal layer on the substrate, depositing a porous metal layer on the first side of the metal layer, releasing the membrane from the substrate, and depositing a second porous metal layer on the second side of the metal layer. Other layers and structures may be provided or deposited, but the foregoing represents one specific embodiment of this enhanced fabrication design. As noted, the metal layer may comprise palladium, but may also include platinum (Pt), niobium (Nb), vanadium (V), iron (Fe), tantalum (Ta), and alloys thereof. The porous metal may include porous versions of the aforementioned metals. As discussed herein, palladium and palladium black will be referenced as the metal and porous metal layers, respectively, but it is to be understood that any of the foregoing may be employed.

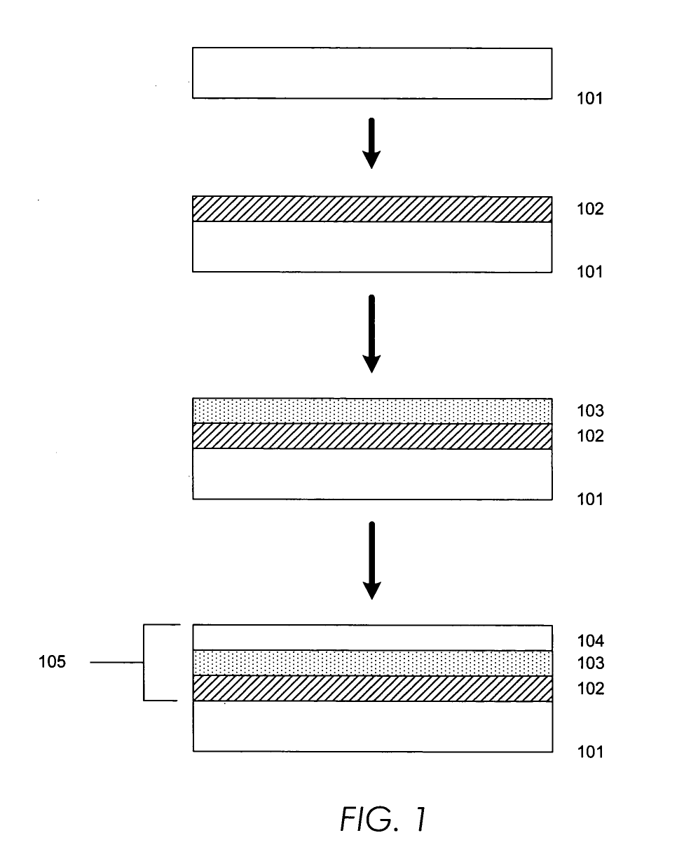

FIG. 1 shows an embodiment of the design. The substrate 101 can be a polytetrafluoroethylene (PTFE) substrate or any surface treated to have perfluorinated carbon located thereon. The substrate with low adhesion surface can be achieved by coating any reasonable surface with a low adhesion releasing layer, such as a layer of Teflon AF, made by du Pont, or Cytop, made by Asahi Glass. Teflon AF or Cytop can be dissolved in perfluorinated solvent and diluted to a low concentration suitable to provide a thin, uniform coating over a material. Alternately, a construction of fluorocarbon polymer deposition by PECVD using CHF₃ gas may be employed.

Palladium layer 102 is deposited on the substrate 101, followed by a layer of palladium-black 103. A polymer electrolyte 104, such as Nafion™ or a sulfonated PEEK/PEK can be applied in a fluidified form onto the palladium-black layer 103 to make a polymer electrolyte coated palladium-black surface. The fluidity of the polymer electrolyte 104 tends to fill the space in the fragile palladium-black structure 103 without crushing the microstructure, and can later be cured. Platinum or platinum-ruthenium nanoparticles can optionally be deposited on the palladium-black surface 103 to increase electrochemical activity of the surface. The combined structure formed is combined palladium thin layer/polymer electrolyte assembly 105.

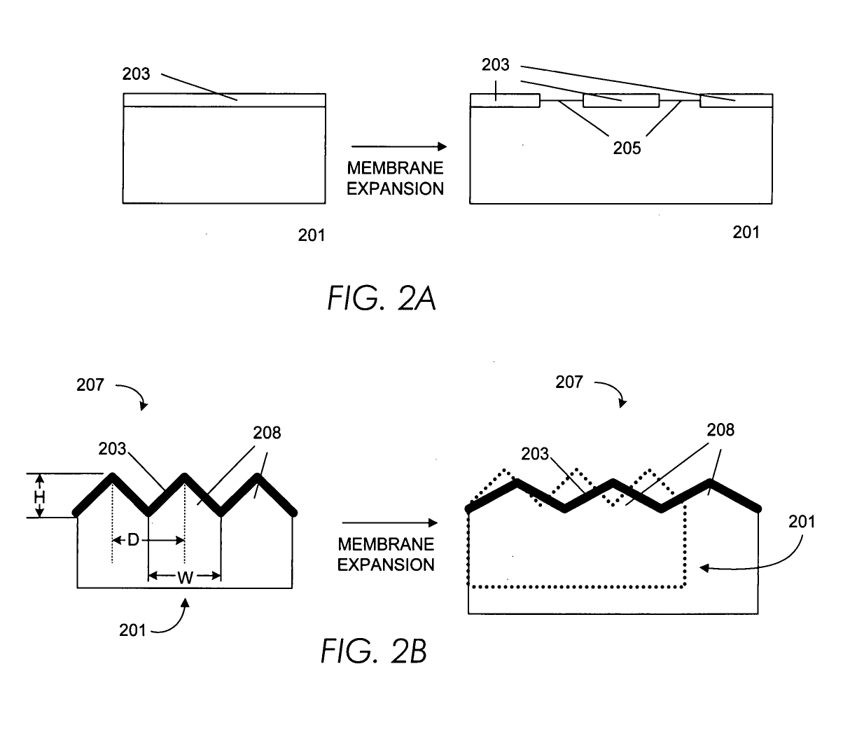

FIG. 2A illustrates a polymer electrolyte membrane absorbing water in a high humidity environment and expanding in volume, while FIG. 2B represents a microtextured surface having multiple protrusions. The metal layer 203 may serve as a catalyst, such as in the case of Pd or Pd alloy. The reactivity of the catalyst can be enhanced by a plasma oxidization process or by using a porous deposit of fine catalyst powders such as Pt black and Pd black. Both Pt black and Pd black have been used as surface modification of electrodes to improve the hydrogenation rate (See, Inoue H. et al. “Effect of Pd black deposits on successive hydrogenation of 4-methylstyrene with active hydrogen passing through a Pd sheet electrode” Journal of The Electrochemical Society, 145: 138-141, 1998; Tu W-Y et al. “Study of the powder/membrane interface by using the powder microelectrode technique I. The Pt-black/Nafion® interfaces” Electrochimica Acta, 43 3731-3739, 1998).

Examples of the catalyst include, but are not limited to, any noble metal catalyst system. Such catalyst systems comprise one or more noble metals, which may also be used in combination with non-noble metals. One noble metal material comprises an alloy of platinum (Pt) and ruthenium (Ru). Other catalyst systems comprise alloys of platinum and molybdenum (Mo); platinum and tin (Sn); and platinum, ruthenium and osmium (Os). Other noble metal catalytic systems may be similarly employed. The catalyst can be deposited onto the metal layer 103 by electroplating, sputtering, atomic layer deposition, chemical vapor deposition, or any other process that is capable of coating the surface of a conductive material.

From FIGS. 2A and 2B, metal layer 203 can include a microtextured surface 207 on the polymer electrolyte membrane 201. The microtextured surface 207 can contain protrusions 208. Under certain conditions, as described in more detail below, cracks 205 may form in the metal layer 203.

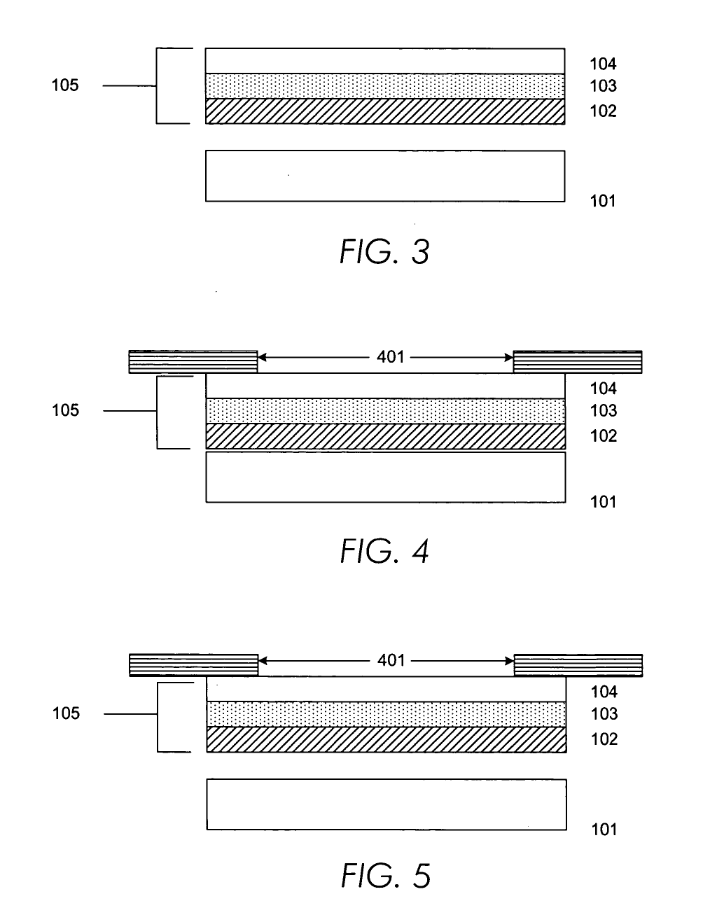

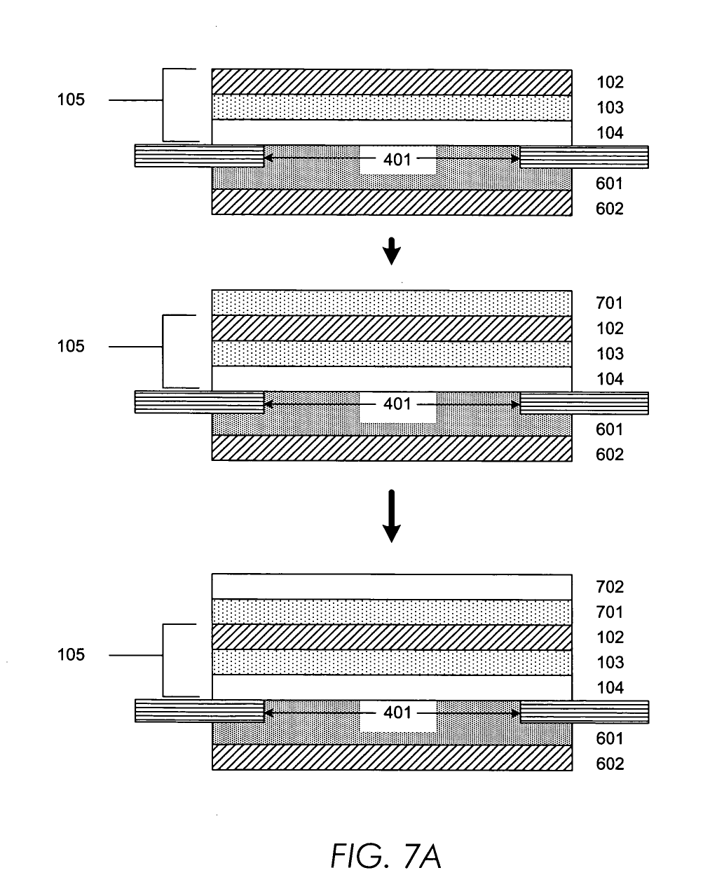

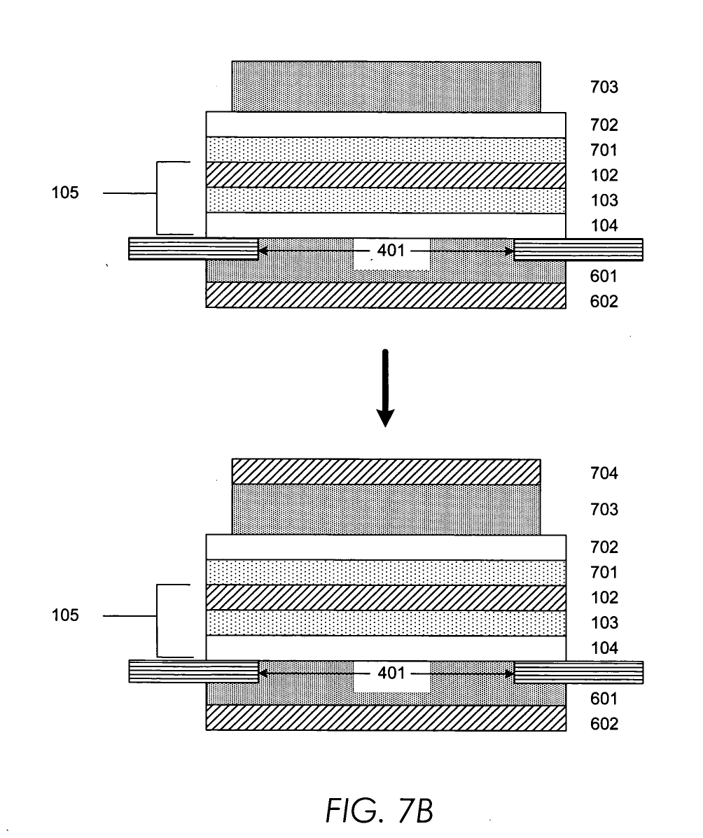

Following deposition of the polymer electrolyte 104, one of two possible paths may be taken to proceed in fabricating the enhanced fuel cell. FIG. 3 illustrates removal of the combined palladium thin layer/polymer electrolyte assembly 105 from the substrate 101. Once this combined palladium thin layer/polymer electrolyte assembly 105 has been disassociated from the substrate 101 as shown, fabrication can progress to FIGS. 7A and 7B.

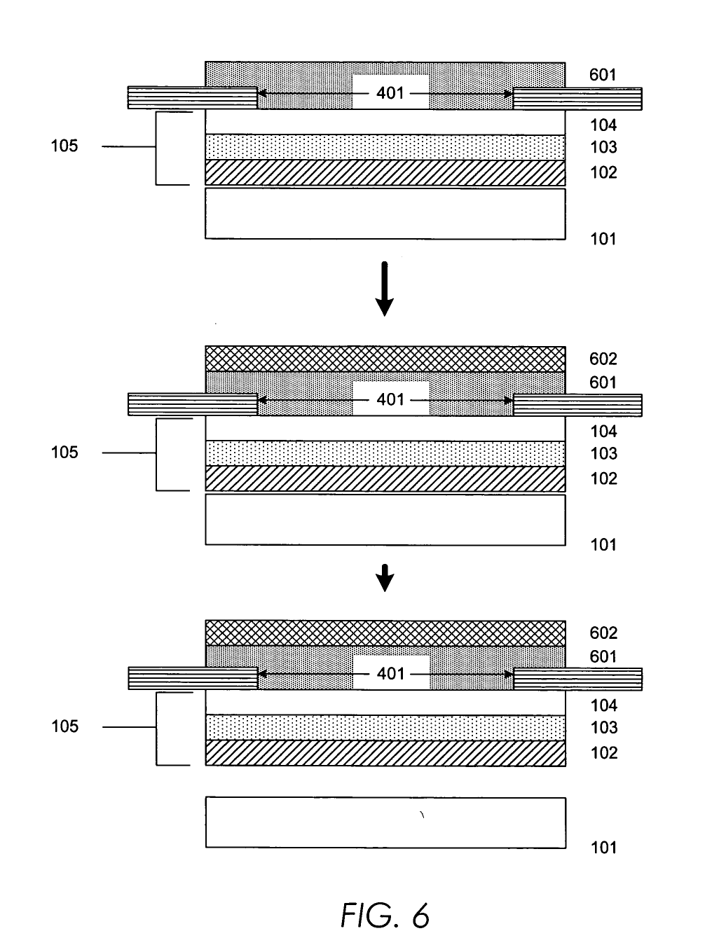

An alternate embodiment, after depositing the polymer electrolyte 104, is illustrated in FIG. 4. From FIG. 4, the polymer electrolyte solution 104 may be applied to the palladium-black surface and then cured, making the polymer electrolyte solution into simply a polymer electrolyte. A frame 401 may be formed adjacent to the polymer electrolyte 104. The frame 401 is a sheet of electrically insulating material not permeable to the fuel and oxidant gases, such as a non-permeable plastic or ceramic, where the frame material can be applied to the edge of the polymer electrolyte 104 to support the combined palladium thin layer/polymer electrolyte assembly 105 and separate the fuel from the oxidants. Once the frame is applied, as shown in FIG. 5, one of two possible paths may be employed, the removal shown in FIG. 5 or the fabrication process shown in FIG. 6.

From FIG. 5, the combined palladium thin layer/polymer electrolyte assembly 105 may be removed from the substrate 101. Fabrication at this point progresses to that shown in FIGS. 7A and 7B.

FIG. 6 illustrates application of a first electrode layer 601 to the frame 401 and combined palladium thin layer/polymer electrolyte assembly 105 and substrate 101. The electrode layer 601 can also be applied directly on the polymer electrolyte coating before releasing the membrane from the substrate. The electrode layer 601 may contain catalyst particles such as platinum, platinum-ruthenium alloy or those supported on carbon black. The electrode layer 601 can be applied by various methods, including but not limited to spraying and painting, at sufficiently low pressure to avoid damaging the fragile membrane. The electrode layer 601 reinforces the membrane and protects the membrane from damage. A gas diffusion/current collecting layer 602 can be provided over the electrode layer to further reinforce the structure. The fabrication process then entails removing the entire structure from the substrate 101.

FIGS. 7A and 7B show all fabrication processes executed subsequent to the fabrication processes of FIGS. 3, 5, and 6. From FIG. 7A, the topmost layered device represents the result from FIG. 6, and is shown here to represent any generic construct from FIGS. 3, 5, and 6 where the substrate has been separated from the palladium layer 102. FIGS. 7A and 7B illustrate depositing further layers atop the palladium layer 102, and thus the structure beneath palladium layer 102 in FIGS. 7A and 7B may be any of the combined layers resulting from either FIGS. 3, 5, and 6, and is not limited to the construction shown, and may not include, for example, the frame 401 and electrode 601.

In the topmost drawing of FIG. 7A, the structure of FIG. 6 is inverted following the separation from the substrate 101. The topmost layer, the palladium layer, may be cleaned to remove possible contaminants. Another layer of palladium film can be deposited to heal any possible cracks resulting from the previous processes, and the palladium layer can be deposited using vapor deposition methods such as sputtering and e-beam evaporation, as well as chemical vapor deposition. FIG. 7A illustrates depositing another layer of palladium black 701 on the palladium layer, followed by a second polymer electrolyte 702, such as Nafion™ and/or sulfonated PEEK/PEK, atop the palladium black layer 701. From FIG. 7B, a second electrode 703 may optionally be applied to the second polymer electrolyte 702. The second electrode 703 may be applied by spraying or painting platinum or a platinum-ruthenium catalyst. A second gas diffusion layer or current collecting layer 704 may optionally be applied to the second electrode. This completes fabrication of the structure, where at a minimum the structure includes palladium film, covered on both sides by palladium-black layers, in turn covered by two layers of polymer electrolyte. One embodiment adds two electrodes positioned outward from the polymer electrolyte, where one electrode may be formed on a frame covering the polymer electrolyte. The structure may further optionally include two gas diffusion or current collecting layers positioned outward from the electrodes.

One problem with the metal film is cracking during hydration when the polymer electrolyte membrane that the metal film covers expands in volume. Palladium is also costly, and application of palladium in a thin film is also expensive. As demonstrated in FIG. 2A, when a polymer electrolyte membrane 201 is covered with a thin metal layer 203 and then is placed in a high humidity environment, the polymer electrolyte membrane 201 absorbs the water and expands in volume. The volume expansion leads to an enlarged surface area and creates very high stress in the thin metal layer 203, which eventually results in cracks 205 in the thin metal layer 203. Fuel molecules can then permeate the polymer electrolyte membrane 201 through the cracks 205.

The metal-coated polymer electrolyte membranes may be used as PEMs in low temperature fuel cells, and preferably in PEM-based direct methanol fuel cells. In an embodiment, one side of the PEM is microtextured and covered by the thin metal layer 103 to prevent fuel crossover. In another embodiment, both sides of the PEM are microtextured and covered by the thin metal layer 203.

Alternate Fuel Cell Fabrication Using Sacrificial Mold

An alternate implementation of the fuel cell is a first embodiment employing a mold with a sacrificial layer in the fabrication of the fuel cell. Alternately, a second embodiment may use a microstructure as described above, either alone or in combination with the mold and sacrificial layer. For the first embodiment, a surface textured silicon wafer or metal mold may be coated with a thin sacrificial layer, followed with a proton/hydrogen permeable metal layer. In the second embodiment, the metal layer-coated mold may then be used to produce a microstructure on a surface of a polymer electrolyte membrane. A porous metal layer may be deposited on the structure, as well as a perfluorinated sulfonic acid on the metal layer. Finally, the proton/hydrogen permeable metal layer may be removed from the silicon wafer or the metal mold. If a microstructure is used, the metal layer may be placed on top of the microstructure of the surface of polymer electrolyte membrane to form a metal coated polymer electrolyte membrane.

The expansion-induced cracking of the metal layer 203 as shown in FIG. 2A can be avoided by creating a microtextured surface 207 on the polymer electrolyte membrane 201. As shown in FIG. 2B, the microtextured surface 207 contains many protrusions 208 that flatten out when the polymer electrolyte membrane 201 expands in water. During the flattening process, the thin metal layer 203 covering the microtextured surface 207 relieves the expansion-induced stress by rotating towards the center plane of the polymer electrolyte membrane 201, while maintaining the continuity of the metal layer 203. The protrusions 208 can be separated from each other by a flat surface of limited size.

The polymer electrolyte membrane 201 may be a sulfonated derivative of a polymer that includes a lyotropic liquid crystalline polymer, such as a polybenzazole (PBZ) or polyaramid (PAR or Kevlar™) polymer. Examples of polybenzazole polymers include polybenzoxazole (PBO), polybenzothiazole (PBT) and polybenzimidazole (PBI) polymers. Examples of polyaramid polymers include polypara-phenylene terephthalimide (PPTA) polymers.

The polymer electrolyte membrane 201 may also include a sulfonated derivative of a thermoplastic or thermoset aromatic polymer. Examples of the aromatic polymers include polysulfone (PSU), polyimide (PI), polyphenylene oxide (PPO), polyphenylene sulfoxide (PPSO), polyphenylene sulfide (PPS), polyphenylene sulfide sulfone (PPS/SO₂), polyparaphenylene (PPP), polyphenylquinoxaline (PPQ), polyarylketone (PK) and polyetherketone (PEK) polymers. Examples of polysulfone polymers include polyethersulfone (PES), polyetherethersulfone (PEES), polyarylsulfone, polyarylethersulfone (PAS), polyphenylsulfone (PPSU) and polyphenylenesulfone (PPSO₂) polymers. Examples of polyimide polymers include the polyetherimide polymers as well as fluorinated polyimides. Examples of polyetherketone polymers include polyetherketone (PEK), polyetheretherketone (PEEK), polyetherketone-ketone (PEKK), polyetheretherketone-ketone (PEEKK) and polyetherketoneetherketone-ketone (PEKEKK) polymers.

The polymer electrolyte membrane 201 may include a sulfonated derivative of a non-aromatic polymer, such as a perfluorinated ionomer. Examples of ionomers include carboxylic, phosphonic or sulfonic acid substituted perfluorinated vinyl ethers. The polymer electrolyte membrane 201 may also include a sulfonated derivative of blended polymers, such as a blended polymer of PEK and PEEK.

The polymer electrolyte membrane 201 may have a composite layer structure comprising two or more polymer layers. Examples of composite layer structures are Nafion™ or PBI membranes coated with sulfonated polyetheretherketone (sPEEK) or sulphonated polyetheretherketone-ketone (sPEEKK). The polymer layers in a composite layer structure can be either blended polymer layers or unblended polymer layers or a combination of both.

The polymer electrolyte membrane 201 is chemically stable to acids and free radicals, and thermally/hydrolytically stable to temperatures of at least about 100° C. Polymer electrolyte membranes 201 may have an ion-exchange capacity (IEC) of greater than 1.0 meq/g dry membrane (preferably, 1.5 to 2.0 meq/g) and are highly ion-conducting (typically from about 0.01 to about 0.5 S/cm).

Polymer electrolyte membranes 201 may include fluorocarbon-type ion-exchange resins having sulfonic acid group functionality and equivalent weights of 800-1100, including Nafion™ membranes.

The microtextured surface 207 on the polymer electrolyte membrane 201 comprises a plurality of the protrusions 208. The protrusions 208 can be in a shape of waves, ripples, pits, nodules, cones, polyhedron, or the like, so long as most of the surfaces of the protrusions 208 form an angle with a central plane of the polymer electrolyte membranes 201 and there are minimal flat surfaces between the protrusions 208.

The microtextured mold can also be fabricated by other commonly used surface treatment processes such as LIGA (a technique used to produce micro electromechanical systems made from metals, ceramics, or plastics utilizing x-ray synchrotron radiation as a lithographic light source), wet chemical etching, dry chemical etching, precession mechanical machining, and laser machining.

In general, for any of the embodiments discussed herein, the metal layer 203 can be deposited onto the microtextured surface 207 of the polymer electrolyte membrane 201 by electroplating, electroless plating, sputtering, evaporation, atomic layer deposition, chemical vapor deposition, or any other process that is capable of coating the surface of a non-conductive material. The thin metal layer 203 comprises a metal or an alloy that is permeable to protons/hydrogen but is not permeable to hydrocarbon fuel molecules, gases such as carbon monoxide (CO), or impurities in the fuel such as sulfur. Examples of such metals or alloys include palladium (Pd), platinum (Pt), niobium (Nb), vanadium (V), iron (Fe), tantalum (Ta), and alloys thereof.

The metal layer 203 can be a discontinuous layer of metal particles, so long as distances between the metal particles are small enough to prevent fuel, gas and impurity crossover in a particular application. The thin metal layer 203 can also be a composite layer comprising multiple layers. For example, Pd and Pt are more corrosion-resistant than Nb, V, Fe and Ta. Therefore, a composite thin metal layer 203 may comprise a first layer of Nb, V, Fe, Ta or an alloy thereof, which is covered by a second layer of Pt, Pd or an alloy thereof.

In this embodiment, the metal layer 203 may be thin enough so that the contour of the microtextured surface 207 is preserved. In other words, the thickness of the metal layer 203 may be relatively small compared to the dimensions of the protrusions 208 on the microtextured surface 207. Typically, the thickness of the thin metal layer 203 is smaller than the average height (H) of surface structures 208. Preferably, the thickness of the thin metal layer 203 is no greater than one third of the average height (H) of the protrusions 208.

In one aspect of a fuel cell design, a PEM-electrode structure may be manufactured utilizing a polymer electrolyte membrane that is microtextured and coated on both sides with the thin metal layer 203 and a catalyst. Porous electrodes that allow fuel delivery and oxygen exchange are then pressed against the catalyst layers of the PEM to form the PEM-electrode structure, which can be used in fuel cell applications.

Use of palladium in fuel cells in the manner shown in FIGS. 2A and 2B may decrease proton transport efficiency. Use of a palladium layer may block fuel crossover, but if such a material causes a significant decrease in proton transport, the palladium layer may not enhance fuel cell performance. Thus additional materials applied to the fuel cell may enhance proton transport performance.

Two approaches are typically employed to enhance reaction rate, namely increasing reaction surface area and using a catalyst. Palladium-black is a material composed of interconnected fine particles of palladium, typically a fine power of a diameter about 0.4 microns that is used as a catalyst. Palladium-black has the ability to increase the reaction surface of palladium due to its porosity and relatively large surface area for a given mass. Palladium-black has been effective in enhancing proton transport from a palladium membrane to a liquid electrolyte. Further, use of platinum to boost reaction rate is also beneficial. While platinum has lower hydrogen permeability, the catalytic activity in hydrogen reduction and oxidation can be significantly higher than that of palladium. The present design therefore employs a combination of palladium and platinum-black to enhance reaction rate. The present design may employ electro-deposition or electroless-deposition to deposit palladium-black and platinum-black. Platinum-black is also a fine powder used as a catalyst. Platinum-black can be prepared by “gas evaporation,” or evaporation into a low pressure gas atmosphere such that gas phase collision and nucleation occurs, thereby depositing a fine particulate material in the evaporation vessel. The present design may deposit palladium-black on the palladium membrane, followed by deposition of platinum-black on the surface of the palladium-black. Such a deposition process may enhance hydrogen transfer between a palladium membrane and platinum-black catalysts.

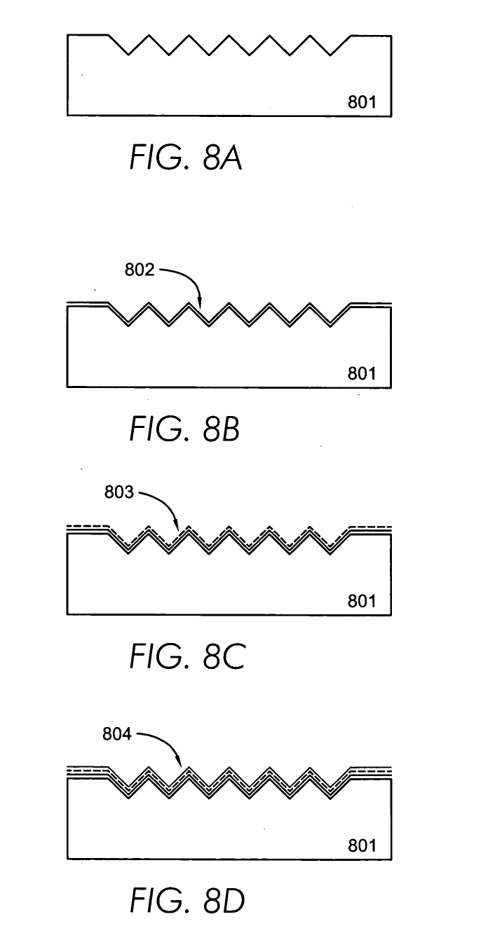

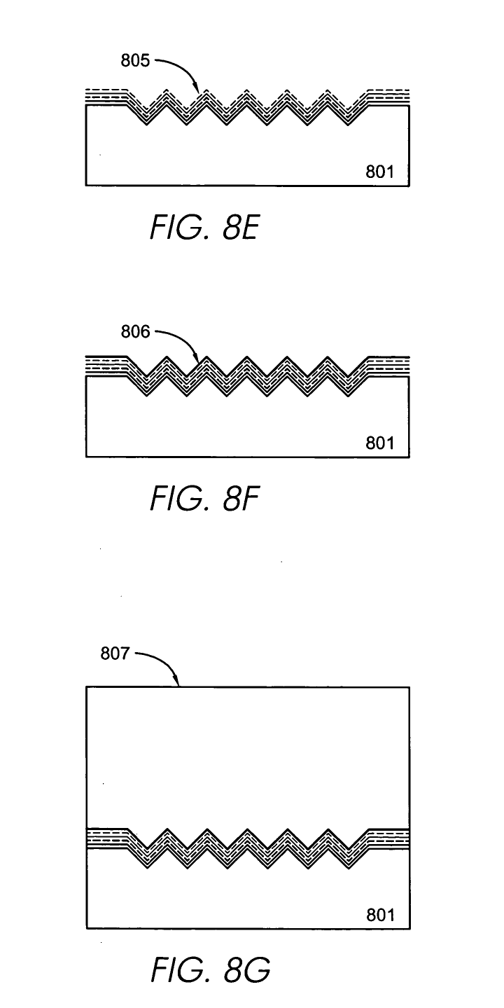

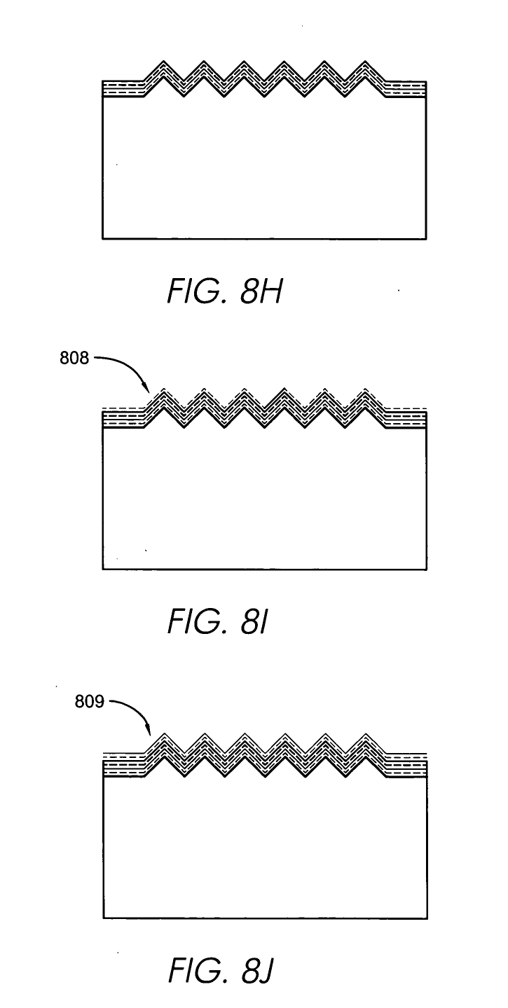

FIGS. 8A-J illustrate an alternate embodiment including use of palladium thin layer with palladium-black and platinum-black on two sides being in sufficient contact with the polymer electrolyte membrane. FIGS. 8A-J are not to scale, and are primarily intended to show the layers that may be deposited and the methodology for creating the fuel cell. From FIG. 8A, the design comprises providing a mold or substrate 801 having an irregular or notched pattern, including but not limited to the representative pattern shown in FIG. 8A, wherein a sacrificial layer 802 is deposited on top of the mold or substrate 801 in FIG. 8B.

While FIGS. 8A-J illustrate use of a mold 801 and sacrificial layer 802 in combination with a microstructure, the present design may encompass use of a mold and sacrificial layer without the microstructure. In such an arrangement, the notched pattern of the mold 801 and sacrificial layer 802 may be omitted and replaced with a flat mold and sacrificial layer and other layers (palladium, platinum-black, and so forth, except palladium-black and the dissolved polymer electrolyte in a solvent) deposited thereon as described below.

The next layer deposited in FIG. 8C is a continuous or relatively uniform layer of palladium 803. A palladium-black layer 804 is deposited on the top of the continuous palladium layer in FIG. 8D, where distribution of the palladium-black layer provides added surface area. The next layer deposited is the platinum-black layer 805 shown in FIG. 8E, which is optional, followed by a layer of dissolved polymer electrolyte in a solvent, such as liquid Nafion™ 806, onto the structure as shown in FIG. 8F. The solvent may then be removed from the structure, and the polymer electrolyte membrane of Nafion™ 806 may be laminated to the cathode 807 by applying heat to the liquid Nafion™ 806, represented in FIG. 8G, followed by removal of the mold or substrate 801 in FIG. 8H. Removal of the mold or substrate 801 and the sacrificial layer 802 releases the membrane from the substrate and essentially leaves an inverted structure atop the cathode 807. The process of removing the mold or substrate 801 may strip off sacrificial layer 802 or leave all or part of the sacrificial layer 802 intact, which can then be removed. On top of this inverted structure may be applied a second layer of palladium-black 808 as shown in FIG. 8I, followed by a second layer of platinum-black 809 as shown in FIG. 8J.

Fabrication in the manner illustrated in FIGS. 8A-J may provide a relatively thin palladium layer or film on a polymer electrolyte membrane having a interfacial high surface area structure with a relatively large contact area. Deposition of the palladium thin layer on top of the sacrificial layer enables releasing the palladium thin layer from the substrate after electrolyte membrane lamination. The overall deposition procedure reduces palladium layer thickness which reduces precious metal consumption and hydrogen diffusion resistance.

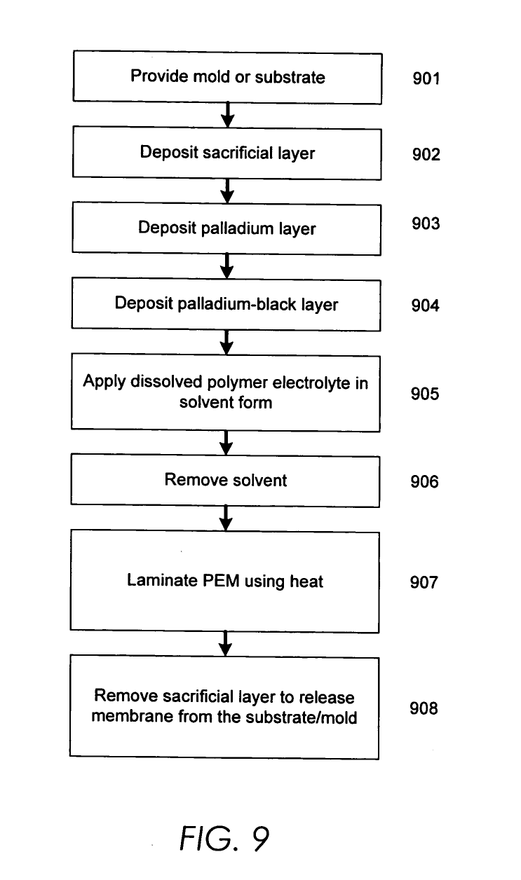

Alternate deposition schemes may be realized that reduce the precious metal costs, inhibit fuel crossover, and provide satisfactory proton transport. As previously noted, the platinum-black layer is optional, and may be omitted if desired. FIG. 9 illustrates a flowchart of an embodiment of the basic deposition arrangement of the present design. Point 901 provides the mold or substrate 801. Point 902 deposits a sacrificial layer 802 on the mold or substrate 801, while point 903 deposits a palladium layer 803 on the sacrificial layer 802. Point 904 calls for depositing a palladium-black layer 804 on the palladium layer 803, while point 905 applies a dissolved polymer electrolyte in a solvent on the palladium-black layer 804. The polymer electrolyte may be, for example, liquid Nafion™ 806. Point 906 calls for removing the solvent applied at point 905, while point 907 heats the polymer electrolyte membrane on the polymer coated palladium-black layer thereby laminating the membrane onto the palladium-black layer 804. Point 908 calls for removing the sacrificial layer to release the membrane from the substrate. The foregoing embodiment therefore entails deposition and layering in accordance with FIGS. 8A, 8B, 8C, 8D, 8F, 8G, and 8H. Addition of further layers such as those shown in FIG. 8A-J can provide further beneficial effects.

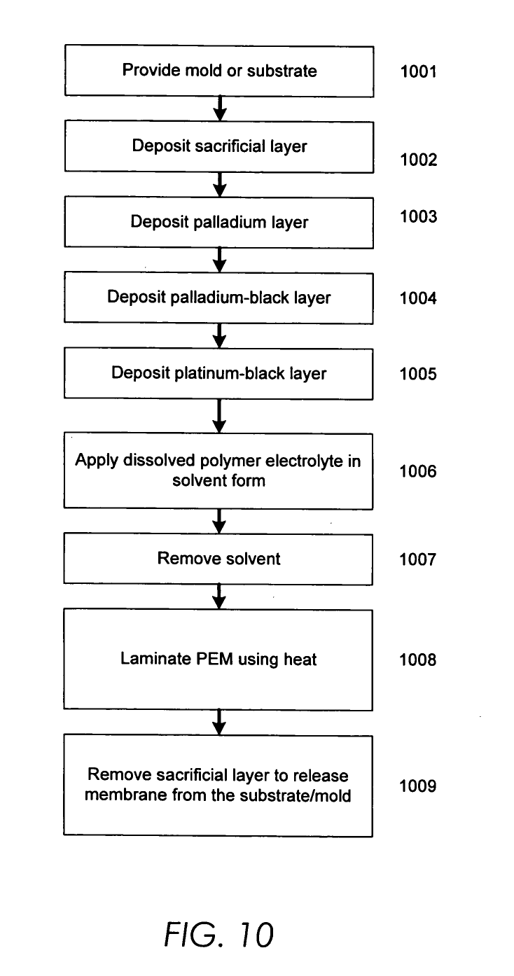

An alternate embodiment of the present design is illustrated in FIG. 10. FIG. 10 uses deposition of platinum-black on the porous palladium-black, thereby tending to enhance surface reaction. Point 1001 provides the mold or substrate 801. Point 1002 deposits a sacrificial layer 802 on the mold or substrate 801, while point 1003 again deposits a palladium layer 803 on the sacrificial layer 802. Point 1004 calls for depositing a palladium-black layer 804 on the palladium layer 803, while point 1005 deposits a platinum-black layer 805 on the palladium-black layer 804. Point 1006 applies a dissolved polymer electrolyte, such as Nafion™ 806, in solvent form on the platinum-black layer 805. Point 1007 calls for removing the solvent applied at point 1006, while point 1008 heats the polymer electrolyte membrane on the polymer coated platinum-black layer thereby laminating the membrane onto the platinum-black layer 805. Point 1009 calls for removing the sacrificial layer to release the membrane from the substrate. The foregoing embodiment therefore entails deposition and layering in accordance with FIGS. 8A-8H. Addition of further layers such as those shown in FIG. 8I-J can provide further beneficial effects.

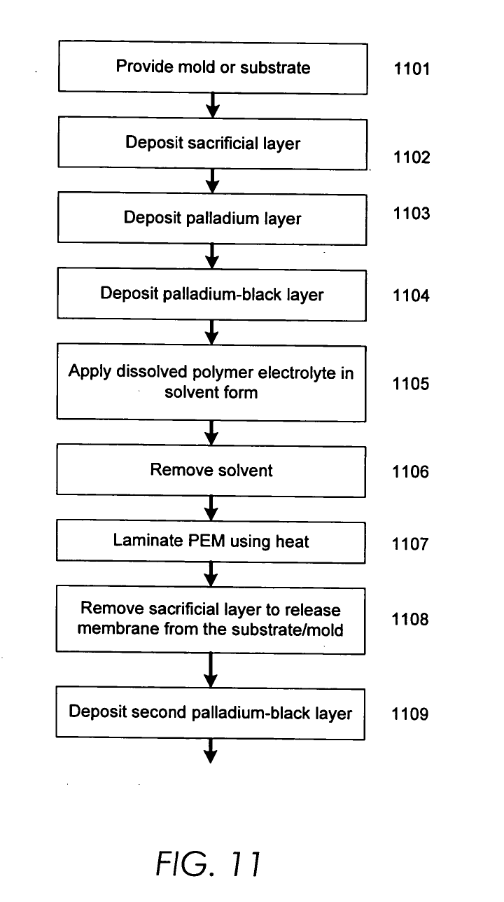

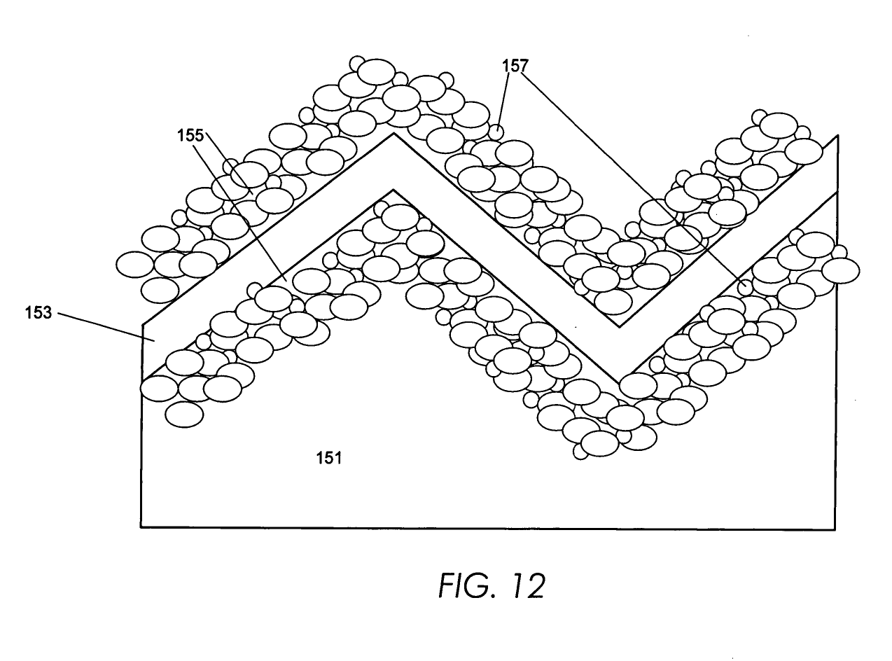

The system may deposit a palladium-black layer on either or both sides of the palladium thin layer to enhance hydrogen absorption after sacrificial layer removal. Thus an alternate embodiment of the present invention may include the aspects presented in FIG. 11, namely providing a substrate or mold 801 at point 1101, depositing a sacrificial layer 802 on the substrate at point 1102, depositing a palladium layer 803 on the sacrificial layer 802 at point 1103, depositing a palladium-black layer 804 on the palladium layer 803 at point 1104, and subsequently applying a dissolved polymer electrolyte, such as Nafion™ 806, in solvent form on the palladium-black layer 804 at point 1105. Point 1106 calls for removing the solvent applied at point 1105, while point 1107 heats the polymer electrolyte membrane of Nafion™ 806 on the polymer coated palladium-black layer 804, thereby laminating the membrane onto the palladium-black layer 804. Point 1108 calls for removing the sacrificial layer 802 to release the membrane from the substrate, while point 1109 calls for depositing a second palladium-black layer 808 onto the palladium layer 803, such as is shown in FIG. 8I. This embodiment therefore entails deposition and layering in accordance with FIGS. 8A-8I. FIG. 12 depicts an embodiment wherein a proton/hydrogen permeable metal layer 151 comprises a continuous metal layer 153 sandwiched between two porous metal layers 155. The porous metal layers 155 are further coated with catalyst particles 157 such as particles of platinum or platinum-ruthenium alloy. The porous metal layers 155 may tend to increase reaction surface area, improve reaction rate, and provide mechanical interlocking between the metal layer 151 and the electrolyte membrane 201.

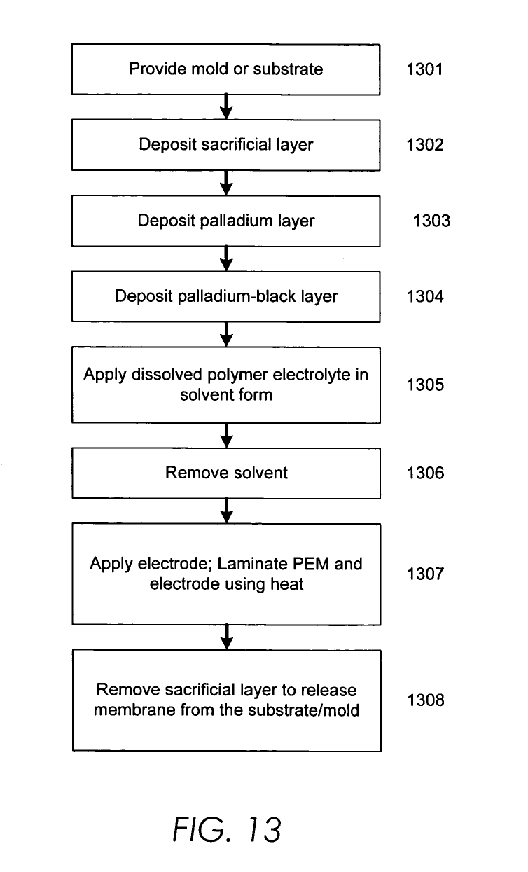

Still another embodiment of the present design entails assembling the catalyst and electrode simultaneously with the electrolyte membrane when the electrolyte membrane is laminated on the palladium layer. Such a process is illustrated in FIG. 13, where point 1301 calls for providing a mold or substrate 801, point 1302 for depositing the sacrificial layer 802, point 1303 for depositing the thin layer of palladium 803 on the sacrificial layer 802, point 1304 depositing the palladium-black layer 804 on the palladium layer 803, and point 1305 applying a dissolved polymer electrolyte, such as Nafion™ 806, in solvent form on the palladium-black layer 804. Point 1306 calls for removing the solvent applied at point 1305. Point 1307 heats the polymer electrolyte membrane and places and heats the electrode 807 on the polymer coated palladium-black layer 804, thereby laminating the membrane onto the palladium-black layer 804. This is an alternate implementation of the heating shown in FIGS. 8F and 8G, wherein both elements, the membrane and the electrode 807, are heated concurrently rather than separately. Point 1308 removes the sacrificial layer 802 to release the membrane from the mold or substrate 801.

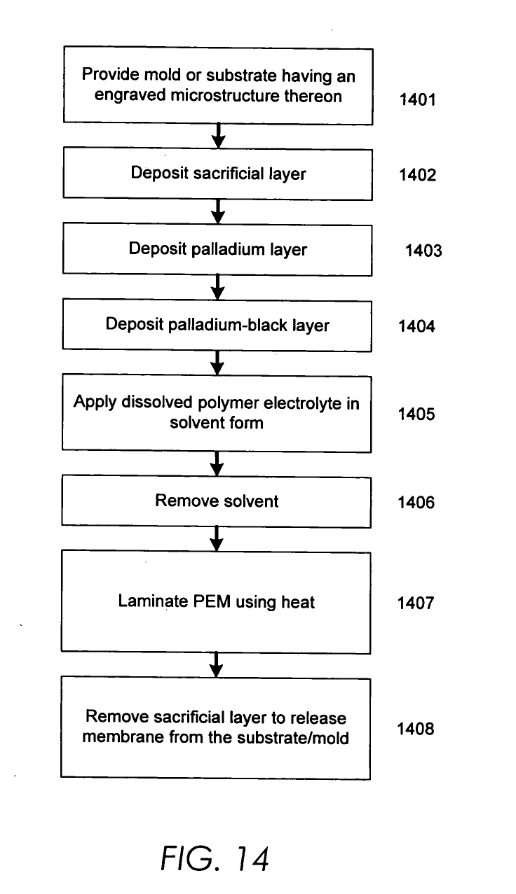

A still further embodiment of the current design can, in certain circumstances, inhibit palladium layer cracking due to deformation of the electrolyte membrane. Such a design includes a microstructure on the membrane surface, where the microstructure can be formed by providing a substrate engraved with the desired microstructure and laminating the membrane against the microstructure. Such a process is illustrated in FIG. 14, where point 1401 provides a substrate or mold 801 having an engraved microstructure thereon. Point 1402 calls for depositing a sacrificial layer 802 on the substrate, while point 1403 deposits a thin palladium layer 803 on the sacrificial layer 802. Point 1404 deposits a palladium-black layer 804 on the palladium layer, while point 1405 applies dissolved polymer electrolyte, such as Nafion™ 806, in solvent form on the palladium-black layer 804. Point 1406 calls for removing the solvent applied at point 1405. Point 1407 heats the polymer electrolyte membrane on the polymer coated palladium-black layer 804. Point 1408 removes the sacrificial layer to release the membrane from the substrate. This is an alternate implementation of the implementation of FIGS. 8A-8H, using a different substrate or mold to reduce the likelihood of cracking of the electrolyte membrane.

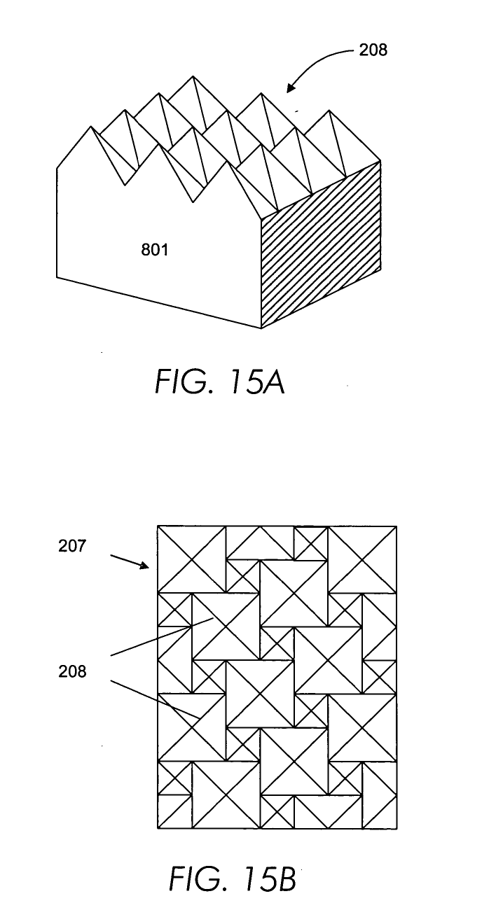

Such an engraved microstructure mold or substrate is illustrated in FIG. 15A, which depicts a microtextured surface of the mold or substrate 801 wherein the protrusions 208 are in a pyramidal shape with no space between protrusions. In this configuration, all surfaces on the protrusions 208 form an angle with a central plane of the mold or substrate. FIG. 15B shows a related embodiment wherein the protrusions 208 have different sizes.

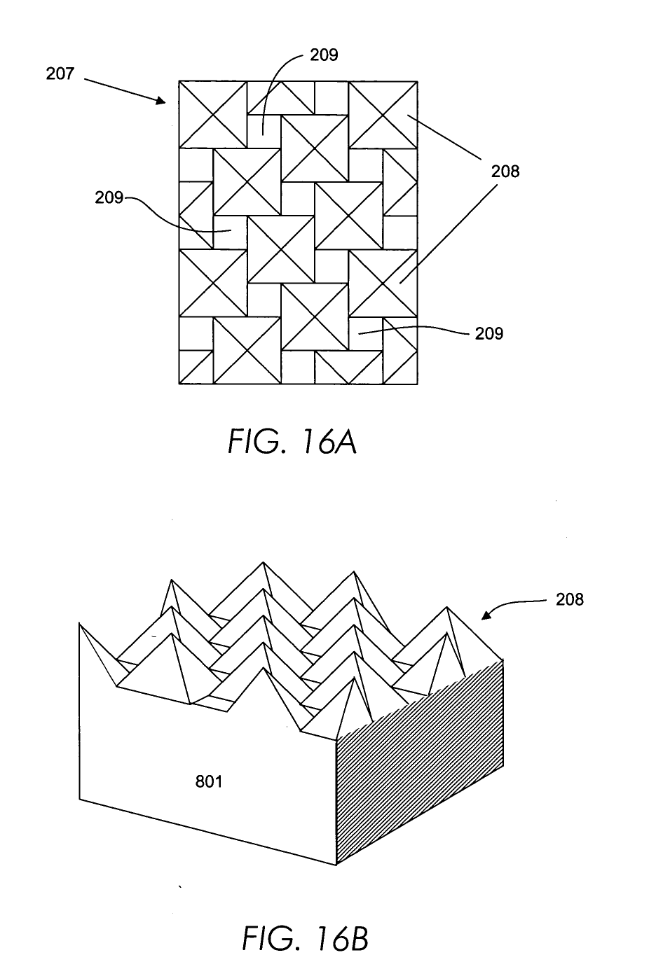

FIGS. 16A and 16B depict protrusions 208 in a pyramidal shape with some limited flat surfaces between protrusions. The flat surfaces can be parallel to the central plane of the mold or substrate 801, so long as the flat surfaces are of limited size and are flanked by protrusions 208 to relieve the expansion-induced stress in the metal layer covering these surfaces. The protrusions 208 in FIGS. 15A, 15B, 16A and 16B can also be in truncated pyramidal shapes. In such a construct, all the surfaces parallel to the central plane may be of limited size and flanked by surfaces forming an angle with the central plane.

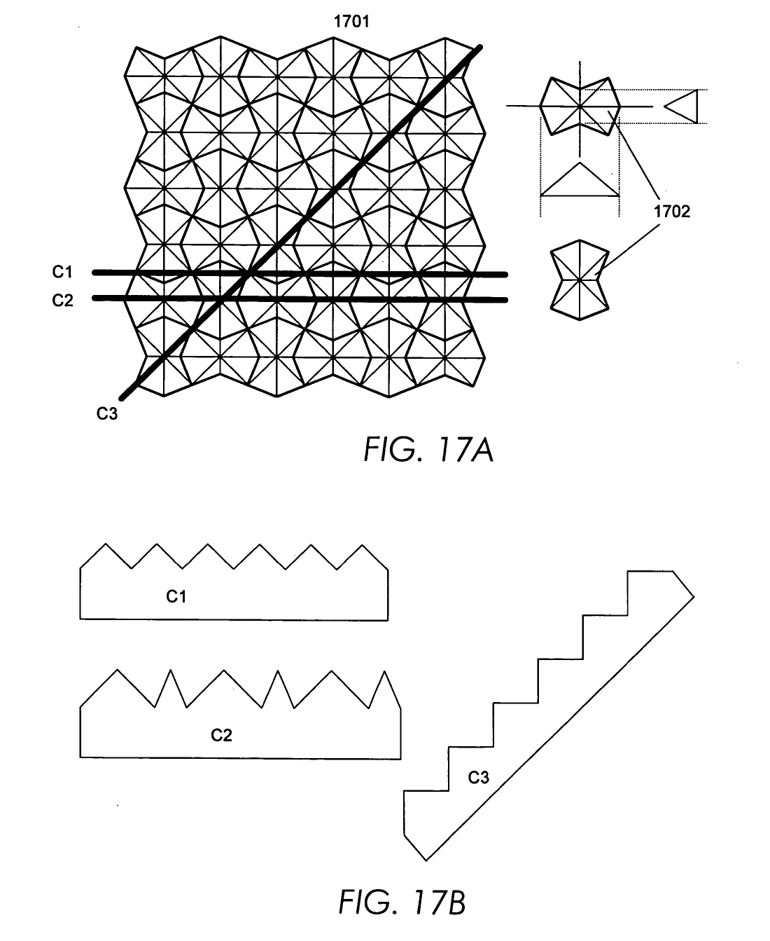

FIG. 17A shows a mold or substrate 1701 wherein each protrusion 1702 has a polyhedral shape. As shown in FIG. 17B, the surface contours of cross-sections C1, C2 and C3 of the surface of the mold or substrate 1701 contain no straight surface line parallel to the central plane of the mold or substrate 1701.

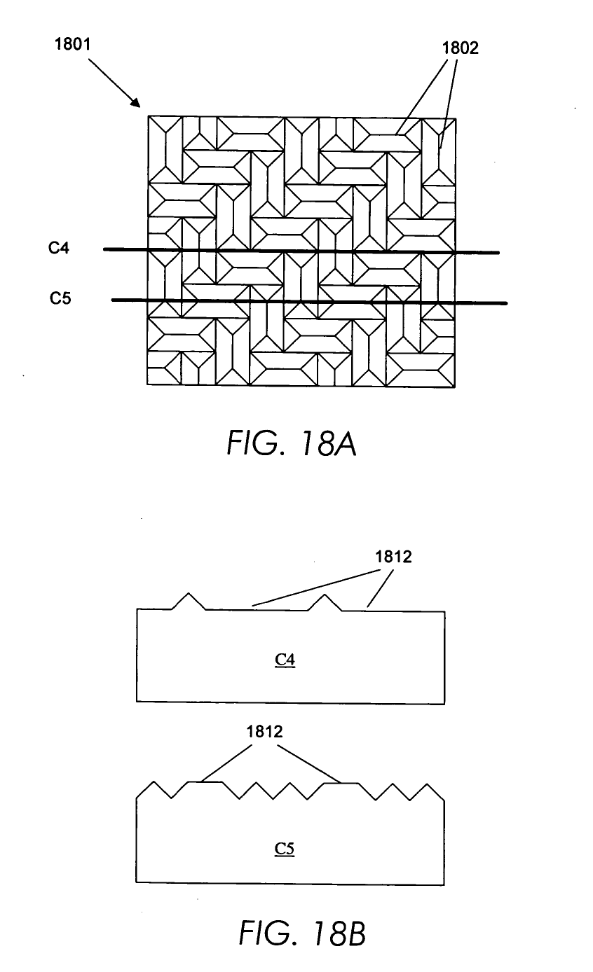

FIG. 18A depicts another surface of a mold or substrate 1801 having roof-like protrusions 1802. This design has no flat surface parallel to the central plane of the mold or substrate 1801. However, as shown in the cross-sectional views in FIG. 18B, some “roof” edge lines 1812 may be parallel to the central plane of the mold or substrate 1801. The parallel lines 1812 are of limited length and are flanked by angled surfaces.

Many other designs are possible for the surface of a mold or substrate 801 with protrusions 208 of different shapes and sizes. The dimension and layout of the protrusions 208 such as those shown in FIG. 2 are generally defined by the average height (H) and average width (W) of the protrusions 208, as well as the average distance (D) between neighboring protrusions. The optimal H, D and W values of a particular surface structure depend on the thickness of the metal layer. Typically, the height (H) of the protrusions 208 is at least three times greater than the thickness (T) of the metal layer 203 so that the contour of protrusions 208 is maintained after coating with the metal layer 203.

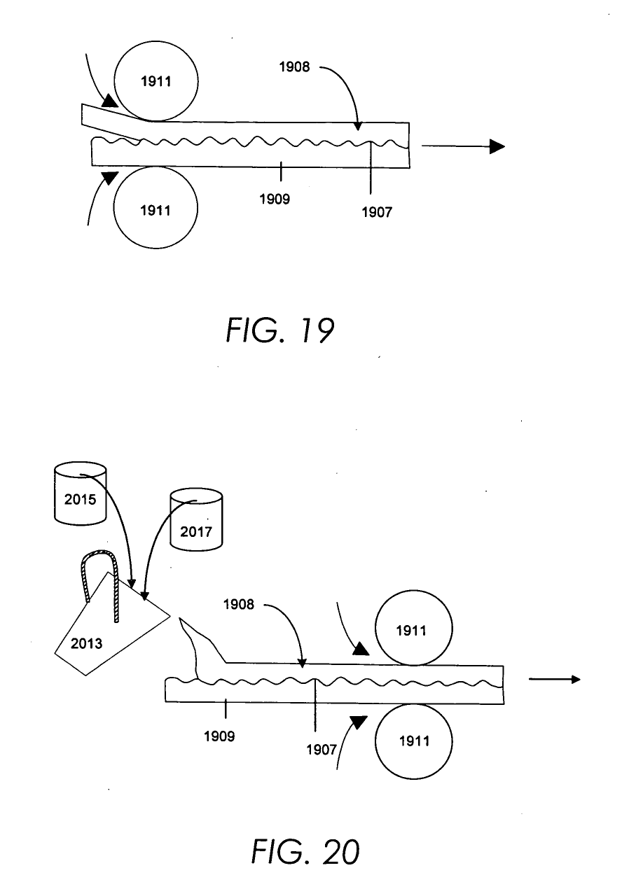

The mold or substrate surface may be created by any chemical, physical or mechanical process that is capable of generating surface microstructures of desired shape and size on the mold or substrate. FIG. 20 shows pouring or casting of material and subjecting the pured or cast material to rollers, while FIG. 19 shows he rolling of a non-liquid layer, such as a layer or solid layer. The surface of the mold or substrate may be created by, for example, direct casting onto the microtextured mold or substrate 1909. A mixture 2013 comprising ion-exchange resins 2015 and a solvent 2017 may be poured onto the microtextured mold 1909 and pressed by the rollers 1911 to form the polymer electrolyte membrane 1908 with a microtextured surface 1907. Alternatively, the mixture 2013 may be poured onto the microtextured mold 1909 and solidified into the polymer electrolyte membrane 1908 having the microtextured surface 1907.

Examples of ion-exchange resins 2015 as shown in FIG. 20 include hydrocarbon- and fluorocarbon-type resins. Hydrocarbon-type ion-exchange resins include phenolic or sulfonic acid-type resins; and condensation resins such as phenol-formaldehyde, polystyrene, styrene-divinyl benzene copolymers, styrene-butadiene copolymers, styrene-divinylbenzene-vinylchloride terpolymers, and the like, that are imbued with cation-exchange ability by sulfonation.

Fluorocarbon-type ion-exchange resins include hydrates of a tetrafluoroethylene-perfluorosulfonyl ethoxyvinyl ether or tetrafluoroethylene-hydroxylated (perfluoro vinyl ether) copolymers. When oxidation and/or acid resistance is desirable, such as at the cathode of a fuel cell, fluorocarbon-type resins having sulfonic, carboxylic and/or phosphoric acid functionality are preferred. Fluorocarbon-type resins typically exhibit excellent resistance to oxidation by halogens, strong acids and bases, and can be preferable for composite electrolyte membranes. One family of fluorocarbon-type resins having sulfonic acid group functionality is the Nafion™ resin family (DuPont Chemicals, Wilmington, Del., available from ElectroChem, Inc., Woburn, Mass., and Aldrich Chemical Co., Inc., Milwaukee, Wis.). Other fluorocarbon-type ion-exchange resins that can be useful in the invention comprise (co)polymers of olefins containing aryl perfluoroalkyl sulfonylimide cation-exchange groups, having the general formula (I): CH₂═CH—Ar—SO₂—N⁻—SO₂(C₁₊ₙF₃₊₂ₙ), wherein n is 0-11, preferably 0-3, and most preferably 0, and wherein Ar is any substituted or unsubstituted divalent aryl group, preferably monocyclic and most preferably a divalent phenyl group. Ar may include any substituted or unsubstituted aromatic moieties, including benzene, naphthalene, anthracene, phenanthrene, indene, fluorene, cyclopentadiene and pyrene, wherein the moieties are preferably molecular weight 400 or less and more preferably 100 or less. Ar may be substituted with any group as defined herein.

The solvent 2017 includes, but is not limited to: tetrahydrofuran (THF), dimethylacetamide (DMAc), dimethylformamide (DMF), dimethylsulfoxide (DMSO), N-Methyl-2-pyrrolidinone (NMP), sulfuric acid, phosphoric acid, chlorosulfonic acid, polyphosphoric acid (PPA), methanesulfonic acid (MSA), lower aliphatic alcohols, water, and a mixture thereof.

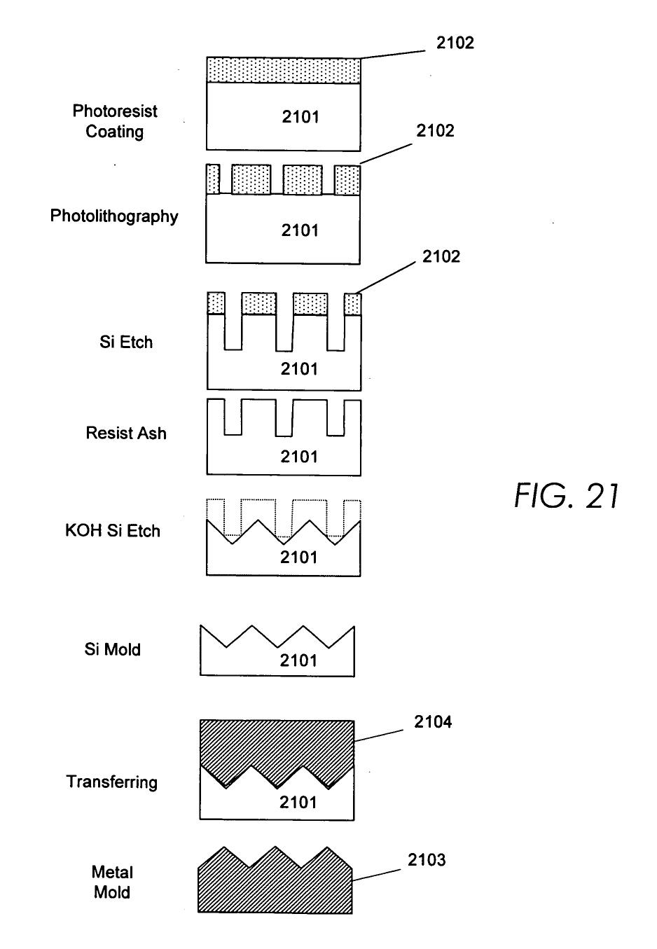

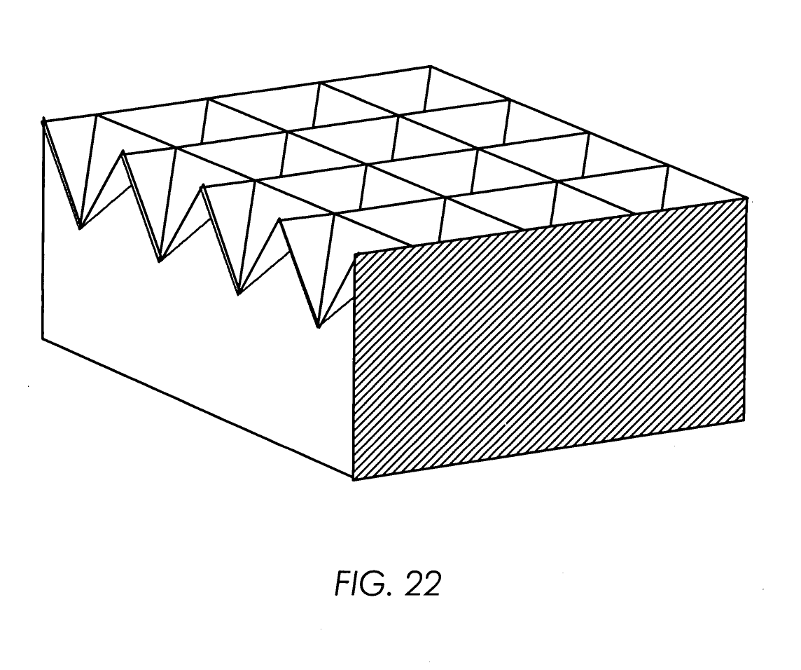

The microtextured mold or substrate 1908 can be produced by any micro fabrication process that is capable of generating surface protrusions 208 of desired shape and dimension. In an embodiment, the microtextured mold or substrate 1908 is made by photolithography and anisotropic etching of a single crystalline silicon wafer 2101 of FIG. 21. As shown in FIG. 21, the microtextured mold or substrate 1908 may be fabricated as follows:
1. Spin-coating the silicon wafer 2101 with a layer of photoresist 2102. In this process, the photoresist 2102 is in a solution with a volatile liquid solvent. The solution is poured onto the silicon wafer 2101, which is rotated at high speed. As the liquid spreads over the surface of the wafer, the solvent evaporates, leaving behind a thin layer of the photoresist 2102 with a thickness of 0.1-50 μm.
2. Exposing the photoresist 2102 to ultraviolet light through a photomask, and washing away the exposed photoresist 2102 with the aid of a chemical developer. The remaining photoresist 2102 forms a desired pattern on the silicon wafer 2101.
3. Anisotropically etching the silicon wafer 2101 to a depth of \sqrt{2}/2×D (D is the distance between two neighboring pattern units, i.e., the distance between the two neighboring protrusions 208, as shown in FIG. 2B) by RIE using fluorine- or chlorine-containing gases and a polymer forming gas.
4. Removing the photoresist 2102 by exposing the silicon wafer 2101 to oxygen plasma to burn the photoresist 2102 or by immersing the wafer 2101 into a photoresist removal solution or solvent.
5. Anisotripically etching the silicon wafer 2101 using KOH, which has 100 times lower etch rate than for differently oriented surfaces. The KOH etching produces pyramid-shaped wells centered at the opening in the silicon wafer 2101. Since certain surfaces are etched faster than other surfaces, at last only slower etched surfaces remain. Once all the other surfaces disappear, the etch rate falls drastically.
6. Transferring the microtextured surface on the silicon wafer 2101 to a metal mold 2103. The transfer of surface structure can be accomplished by depositing a metal layer 2104 on top of the silicon wafer 2101 by electro- or electroless-plating, and then dissolving the silicon wafer 2101 to generate the metal mold 2103.

The final product is shown in FIG. 22. The surface structure of the metal mold 2103 is a negative replica of the microtextured surface of the silicon wafer 2101. The metal mold 2103 can be used as the microtextured mold 1908 to produce the polymer electrolyte membrane 1901 having the microtextured surface 1907.

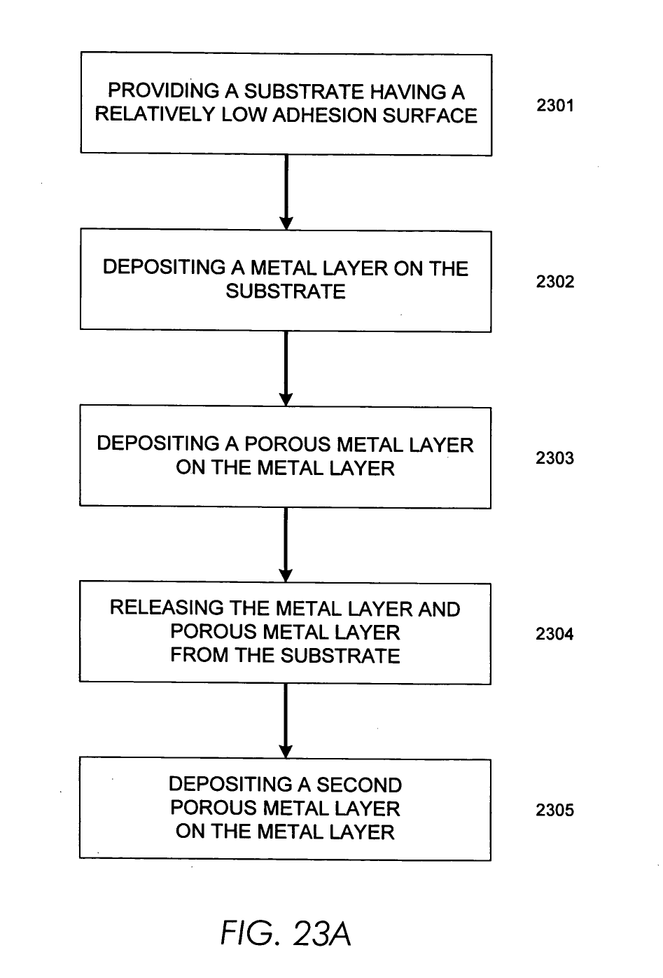

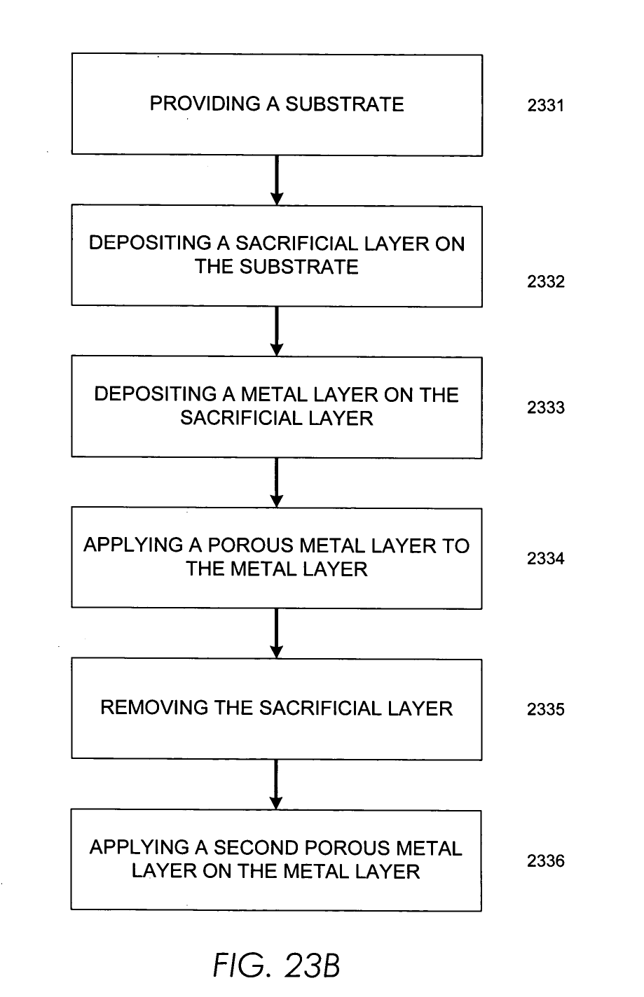

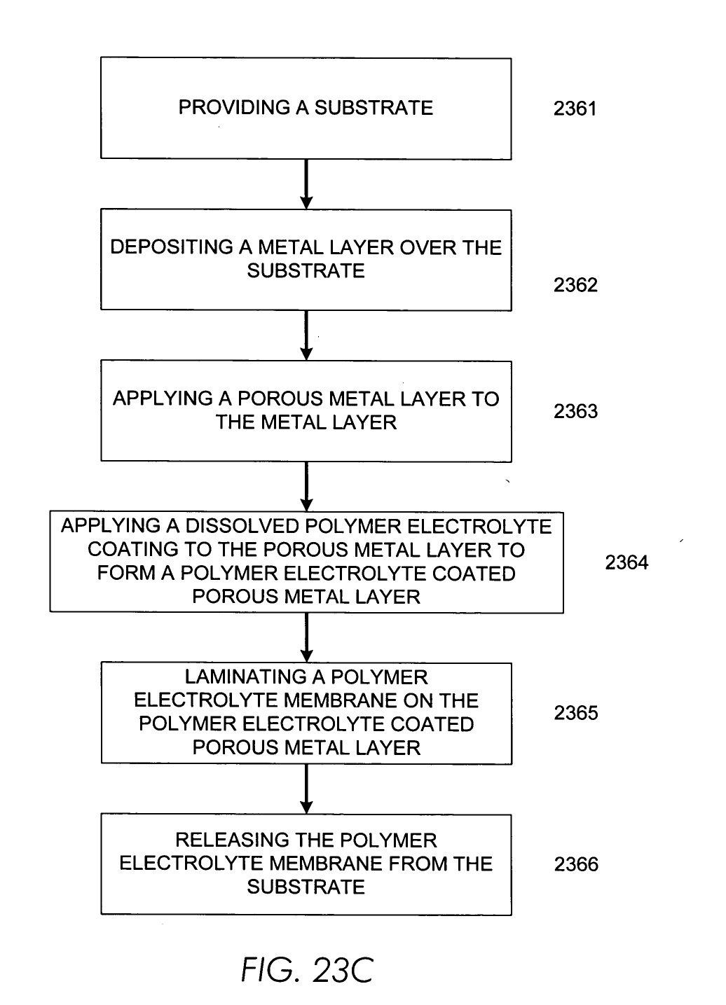

FIGS. 23A, 23B, and 23C provide a general overall illustration of embodiments of the present design. According to FIG. 23A, there is provided a method for producing a fuel cell, comprising point 2301, providing a substrate that in one embodiment may have a relatively low adhesion surface, followed by point 2302, depositing a metal layer on the substrate. Point 2303 calls for depositing a porous metal layer on the metal layer, while point 2304 releases the metal layer and porous metal layer from the substrate. Point 2305 deposits a second porous metal layer on the metal layer.

FIG. 23B presents an alternate embodiment of a method for producing a fuel cell according to the present design. The method includes point 2331, providing a substrate, followed by point 2332, depositing a sacrificial layer on the substrate, and point 2333, depositing a metal layer on the sacrificial layer. Point 2334 entails applying a porous metal layer to the metal layer, while point 2335 calls for removing the sacrificial layer, thereby releasing the polymer electrolyte coating from the substrate. Point 2336 applies a second porous metal layer on the metal layer.

FIG. 23C presents another embodiment of a method for producing a fuel cell according to the present design. The method comprises providing a substrate at point 2361, depositing a metal layer over the substrate at point 2362, and applying a porous metal layer to the metal layer at point 2363. Point 2364 calls for applying a dissolved polymer electrolyte coating to the porous metal layer to form a polymer electrolyte coated porous metal layer, while point 2365 entails laminating a polymer electrolyte membrane on the polymer electrolyte coated porous metal layer. Finally, the method releases the polymer electrolyte membrane from the substrate at point 2366.

It will be appreciated to those of skill in the art that the present design may be applied to other fuel systems that employ polymer electrolyte membranes, particularly those having issues with fuel crossover and/or proton transport. In particular, it will be appreciated that various schemes used to fabricate such fuel cells may be addressed by the functionality and associated aspects described herein.

Although there has been hereinabove described a fuel cell device employing a polymer electrolyte membrane and method for manufacture thereof, for the purpose of illustrating the manner in which the invention may be used to advantage, it should be appreciated that the invention is not limited thereto. Accordingly, any and all modifications, variations, or equivalent arrangements which may occur to those skilled in the art, should be considered to be within the scope of the present invention as defined in the appended claims.

What is claimed is:

1. A method for producing a fuel cell, comprising:
providing a substrate;
depositing a metal layer on the substrate;
depositing a porous metal layer on the metal layer;
releasing the metal layer and porous metal layer from the substrate; and
depositing a second porous metal layer on the metal layer.

2. The method of claim 1, wherein the substrate comprises a relatively low adhesion surface.

3. The method of claim 1, wherein said metal layer comprises a palladium layer.

4. The method of claim 1, wherein said porous metal comprises palladium black.

5. The method of claim 4, wherein said porous metal comprises a layer of platinum black or platinum-ruthenium black on a surface of the porous metal.

6. The method of claim 4, wherein said porous metal comprises palladium black.

7. The method of claim 1, further comprising depositing a polymer electrolyte to the porous metal layer before releasing the metal layer and porous metal layer from the substrate.

8. The method of claim 7, further comprising applying a frame to the polymer electrolyte before releasing the metal layer and porous metal layer from the substrate.

9. The method of claim 7, wherein the polymer electrolyte comprises at least one from a group comprising:
a perfluorinated sulfonic acid; and
sulfonated PEEK/PEK.

10. The method of claim 7, further comprising applying an electrode layer to the polymer electrolyte and before releasing the metal layer and porous metal layer from the substrate.

11. The method of claim 10, further comprising applying a gas diffusion layer after applying the electrode layer and before releasing the metal layer and porous metal layer from the substrate.

12. The method of claim 1, further comprising cleaning the metal layer after releasing the metal layer and porous metal layer from the substrate.

13. The method of claim 1, further comprising applying a quantity of a polymer electrolyte to the second porous metal layer.

14. The method of claim 7, further comprising applying an additional quantity of a polymer electrolyte to the second porous metal layer.

15. The method of claim 8, further comprising applying an additional quantity of a polymer electrolyte to the second porous metal layer.

16. The method of claim 11, further comprising applying an additional quantity of a polymer electrolyte to the second porous metal layer.

17. The method of claim 16, further comprising applying an additional electrode layer on the additional quantity of polymer electrolyte.

18. The method of claim 17, further comprising applying an additional gas diffusion layer to the additional electrode layer.

19. The method of claim 17, wherein the gas diffusion layer and additional gas diffusion layer comprise a current collecting layer.

20. The method of claim 1, wherein the relatively low adhesion surface comprises a microstructure.

21. A fuel cell formed using a substrate having a low adhesion surface, comprising:
a metal layer having a first side and a second side;
a first porous metal layer on the first side of the metal layer; and
a second porous metal layer on the second side of the metal layer;
wherein the fuel cell is formed by depositing the metal layer on the substrate, depositing the first porous metal layer, removing the metal layer and first porous metal layer from the substrate, and depositing the second porous metal layer to the second side of the metal layer.

22. The fuel cell of claim 21, further comprising a first quantity of polymer electrolyte deposited to the first porous metal layer before releasing the metal layer and first porous metal layer from the substrate.

23. The fuel cell of claim 21, further comprising a frame applied to the polymer electrolyte before releasing the metal layer and first porous metal layer from the substrate.

24. The fuel cell of claim 22, wherein the polymer electrolyte comprises at least one from a group comprising:
a perfluorinated sulfonic acid; and
sulfonated PEEK/PEK.

25. The fuel cell of claim 24, further comprising a first electrode layer applied to the frame after applying the frame and before releasing the metal layer and first porous metal layer from the substrate.

26. The fuel cell of claim 25, further comprising a gas diffusion layer applied after the first electrode layer and before releasing the metal layer and first porous metal layer from the substrate.

27. The fuel cell of claim 26, further comprising an additional quantity of a polymer electrolyte applied to the second porous metal layer.

28. The fuel cell of claim 24, further comprising an additional quantity of a polymer electrolyte applied to the second porous metal layer.

29. The fuel cell of claim 27, further comprising an additional quantity of a polymer electrolyte applied to the second porous metal layer.

30. The fuel cell of claim 28, further comprising an additional quantity of a polymer electrolyte applied to the second porous metal layer.

31. The fuel cell of claim 28, further comprising an additional electrode layer applied on the additional quantity of polymer electrolyte.

32. The fuel cell of claim 31, further comprising applying an additional gas diffusion layer to the additional electrode layer.

33. The fuel cell of claim 32, wherein the gas diffusion layer and additional gas diffusion layer comprise a current collecting layer.

34. The fuel cell of claim 21, wherein said metal comprises palladium.

35. The fuel cell of claim 21, wherein said porous metal comprises palladium-black.

36. The fuel cell of claim 35, wherein said porous metal further comprises a layer of platinum-black or platinum-ruthenium black.

37. The fuel cell of claim 34, wherein said porous metal comprises palladium-black.

38. A fuel cell apparatus formed using a substrate, comprising:
a layer of metal applied to the substrate;
a porous metal layer applied to the metal layer;
a polymer electrolyte coating on the porous metal layer, forming a polymer electrolyte coated porous metal layer; and
a polymer electrolyte membrane on the polymer electrolyte coated porous metal layer.

39. The fuel cell apparatus of claim 39, wherein the fuel cell apparatus is produced using a sacrificial layer applied to the substrate, and wherein the polymer electrolyte membrane is released from the sacrificial layer and substrate to form the fuel cell apparatus.

40. The fuel cell apparatus of claim 39, wherein said substrate comprises a substrate having an engraved microstructure formed thereon.

41. The fuel cell apparatus of claim 39, wherein said layer of metal comprises palladium, and said porous metal layer comprises palladium-black.

42. The fuel cell apparatus of claim 39, further comprising one from a group comprising a layer of platinum black and platinum-ruthenium black located between the porous metal layer and the polymer electrolyte coating.

43. The fuel cell apparatus of claim 39, wherein the polymer electrolyte coating comprises one from a group comprising a perfluorinated sulfonic acid and sulfonated PEEK/PEK.

44. The fuel cell apparatus of claim 39, further comprising applying a polymer electrolyte coating to the porous metal layer to form a polymer electrolyte coated metal assembly.

45. The fuel cell apparatus of claim 45, further comprising an electrode positioned on the polymer electrolyte coating.
